(19) United States
(12) Patent Application Publication
(10) Pub. No.: US 2013/0080560 A1
(43) Pub. Date: Mar. 28, 2013

(54) System and Method for Sharing Digital Data on a Presenter Device to a Plurality of Participant Devices

(71) Applicants: Tushar Sayankar, Gurnee, IL (US); Tjin Wung Aow, Palatine, IL (US)

(72) Inventors: Tushar Sayankar, Gurnee, IL (US); Tjin Wung Aow, Palatine, IL (US)

(73) Assignee: SMITH MICRO SOFTWARE, INC., Aliso Viejo, CA (US)

(21) Appl. No.: 13/242,324

(22) Filed: Sep. 23, 2011

(51) Int. Cl. G06F 15/167

(52) U.S. Cl. 709/212

(57) ABSTRACT

There is provided a system and method for sharing a plurality of data contents from a presenter device to a plurality of participant devices. There is provided a system comprising a processor configured to execute a data sharing application, wherein the data sharing application is configured to receive a selection of the plurality of data contents, connect to the plurality of participant devices using a hotspot service executing on the presenter device, establish a sharing session with the plurality of participant devices, and present the plurality of data contents onto the plurality of participant devices. Accordingly, the presenter device maintains full control over the plurality of data contents being shared and reduces the time for sharing and the bandwidth consumed for presenting the plurality of data contents.

### BACKGROUND OF THE INVENTION

1. Field of the Invention

The present invention relates generally to the sharing of digital data. More particularly, the present invention relates to presenting data contents from a presenter mobile device to a plurality of participant mobile devices.

2. Background Art

Presenting digital data from a presenter mobile device to a plurality of participant mobile devices, which are in close proximity to the presenter mobile device, can be accomplished with conventional methods. For example, a user desiring to present a number of digital vacation photographs onto the mobile devices of colleagues, who may be in the same conference room as the user, may do so by using electronic mail (e-mail) services. The user may send an e-mail to his colleagues with the digital vacation photographs attached. Another method of presenting the digital vacation photographs may involve uploading the photographs to an Internet web server so the colleagues may view the photographs through a web browser.

However, the above conventional methods of presenting digital data onto a plurality of mobile devices have certain drawbacks. One drawback is that the conventional methods do not allow the sharer to dictate how the data may be shared. Once the sharer sends the photographs through an e-mail or uploads the photographs onto a third-party web server, the sharer no longer controls the order in which the photographs are shown. Moreover, once the photographs are shared, the sharer cannot prevent others from copying and distributing the shared data even if the sharer prefers, for privacy or other reasons, to prevent such copying and distributing.

Moreover, conventional methods for sharing data may also potentially consume more time and bandwidth than the sharer may prefer. Uploading larger data files, such as video files, to an Internet web server or attaching them to an e-mail may require a long wait time. Some e-mail services may even forbid the attachment of data files that exceed a set size. Additionally, the consumption of network resources by upload operations may negatively impact network quality of service.

Accordingly, there is a need to overcome the drawbacks and deficiencies in the art by providing a method to share digital data easily from one mobile device to other mobile devices while allowing the sharer to maintain control over the shared data and while preserving network resources.

### SUMMARY OF THE INVENTION

There is provided systems and methods for sharing a plurality of data contents on a presenter device to a plurality of participant devices, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 presents an illustration of an environment in which an exemplary presenter device may present, onto a plurality of participant devices, a plurality of data contents, according to one embodiment of the present invention;

FIG. 2 is a block diagram of an exemplary presenter device for presenting, onto a plurality of participant devices, a plurality of data contents, according to one embodiment of the present invention;

FIG. 3 is an illustration of an exemplary presenter device for presenting, onto a plurality of participant devices, a plurality of data contents, according to one embodiment of the present invention;

FIG. 4a presents an illustration of one participant device receiving a share invitation from a presenter device, according to one embodiment of the present invention;

FIG. 4b presents an illustration of the participant device of FIG. 4a presenting data content stored on a presenter device after accepting a share invitation, according to one embodiment of the present invention; and

FIG. 5 shows a flowchart describing the steps, according to one embodiment of the present invention, by which a plurality of data contents may be presented onto a plurality of participant devices present within a hotspot signal range, according to one embodiment of the present invention.

### DETAILED DESCRIPTION OF THE INVENTION

The present application is directed to a system and method for sharing a plurality of data contents on a presenter device to a plurality of participant devices. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

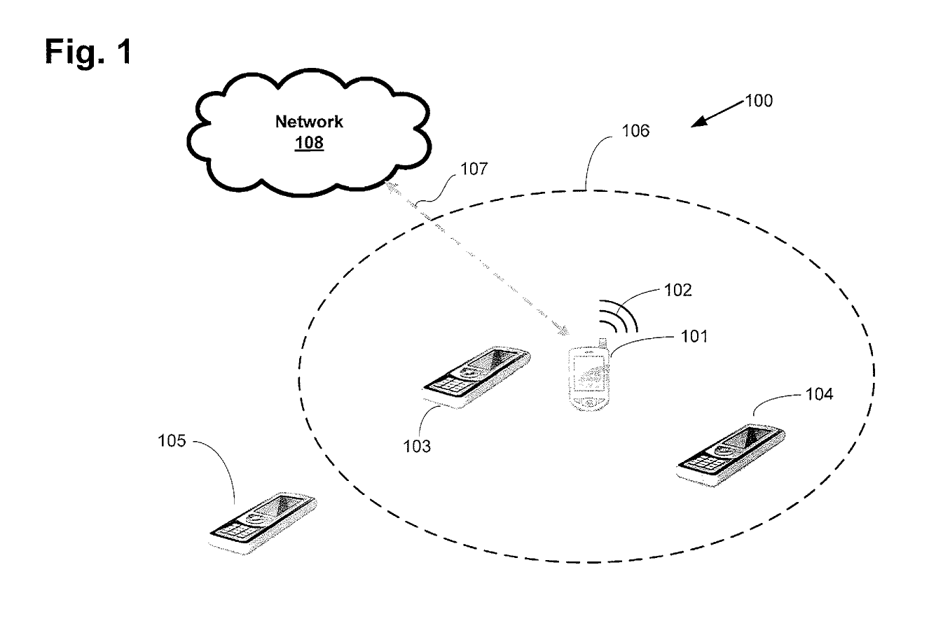

FIG. 1 presents an illustration of an environment in which an exemplary presenter device may present, onto a plurality of participant devices, a plurality of data contents, according to one embodiment of the present invention. Environment 100 of FIG. 1 includes presenter device 101, hotspot signal 102, participant devices 103, 104 and 105, hotspot signal range 106, network connection 107, and network 108.

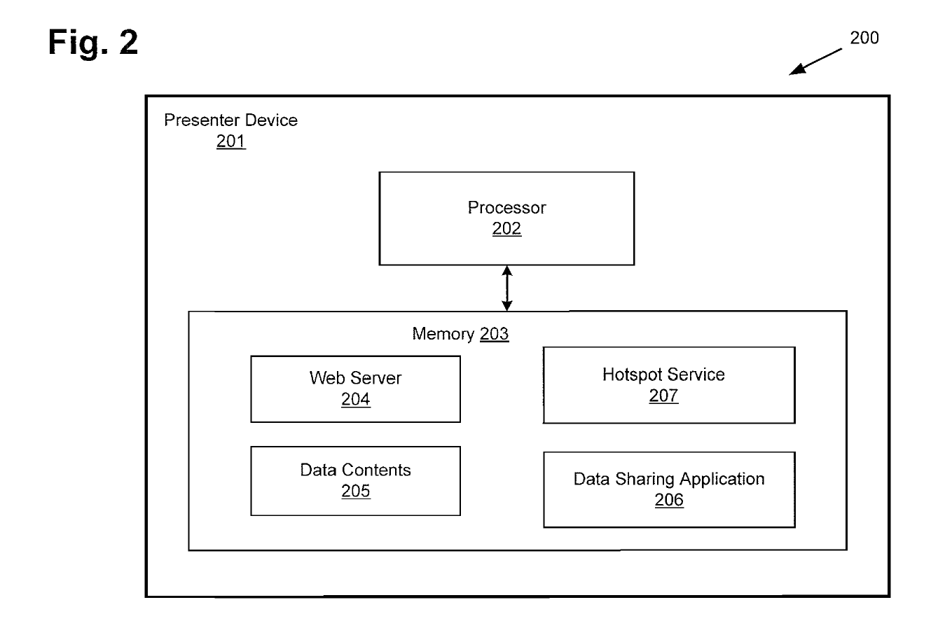

Presenter device 101 may be any type of mobile device, such as a smartphone, for example. Presenter device 101 may be connected to network 108 through network connection 107. Network 108 may be any type of network, such as the Internet, for example. Network connection 107 may be any type of wireless signal recognized by presenter device 101. Presenter device 101 may run a hotspot generation application to generate hotspot signal 102. Hotspot signal range 106 may be the physical range of hotspot signal 102. Hotspot generation application may be any kind of application that allows presenter device 101 to behave as a wireless router. Hotspot signal 102 may be any kind of wireless signal, such as a Wi-Fi signal, for example. Other mobile devices such as, for example, participant devices 103 and 104, within hotspot signal range 106 may be able to connect to network 108. As will be explained in further detail below, presenter device 101 may run data sharing application 206 of FIG. 2. A user of presenter device 101, which may be executing data sharing application 206, may select a plurality of data contents from presenter device 101 to present to a plurality of participant devices within hotspot signal range 106.

Participant devices 103-105 may be various types of mobile devices, such as, for example, smartphones. In the embodiment shown in FIG. 1, participant devices 103 and 104 may be located within hotspot signal range 106 and participant device 105 may be located outside of hotspot signal range 106. Since participant devices 103 and 104 are located within hotspot signal range 106, presenter device 101, using data sharing application 206, may share a plurality data contents with participant devices 103 and 104. Participant device 105 is located outside hotspot signal range 106 and may not view the plurality of data contents on presenter device 101 using the hotspot signal 102. In other environments, any number of mobile devices may be present within hotspot signal range 106, and presenter device 101 may connect to some or all of the mobile devices in order to share the plurality of data contents.

FIG. 2 is a block diagram of an exemplary presenter device for presenting, onto a plurality of participant devices, a plurality of data contents, according to one embodiment of the present invention. Block diagram 200 of FIG. 2 includes presenter device 201. Presenter device 201 includes processor 202 and memory 203. Memory 203 includes presenter server 204, data 205, hotspot service 207, and data sharing application 206. Presenter device 201 may correspond to presenter device 101 of FIG. 1.

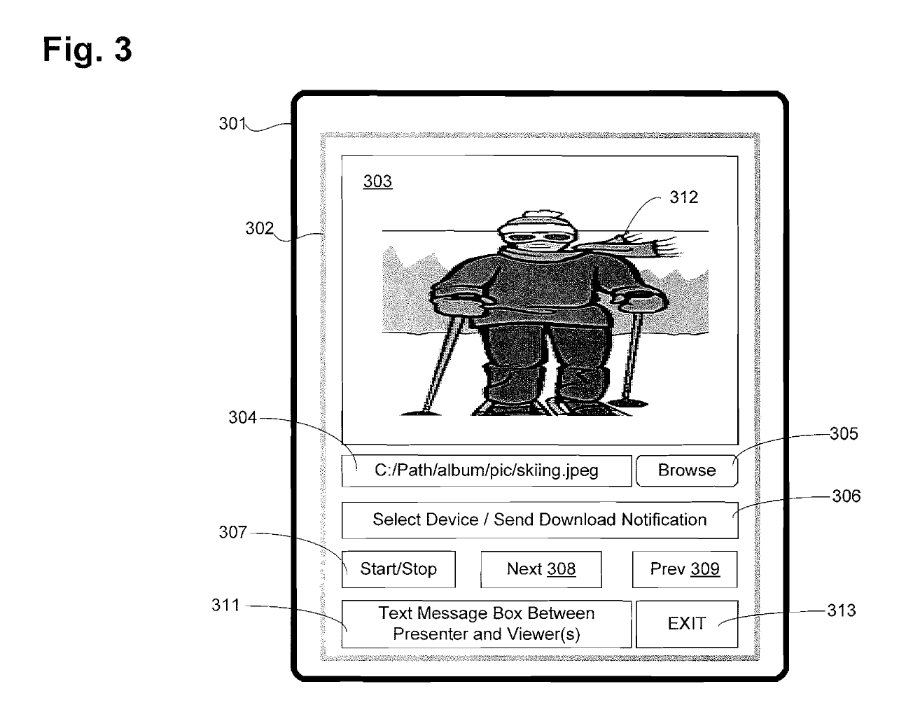

Processor 202 may be any type of processing unit such as, for example, an Intel Core processor. Memory 203 may be any type of computer readable storage device, such as a hard drive with many gigabytes of memory, for example. Presenter server 204 may be any type of web server, which may be maintained and managed by processor 202. Data 205 may represent a collection of numerous data files such as, for example, image files, audio files, video files or any other type of digital data. Hotspot service 207 may be a hotspot generation application that may be stored into memory 203. Hotspot service 207, executed by processor 202, may allow presenter device 201 to behave as a wireless router. Data sharing application 206, a software application executed by processor 202, may allow presenter device 201 to select a plurality of data contents from data 205 to be presented on a plurality of participant devices in the signal frequency range created by hotspot service 207. In one embodiment, data 205 may comprise of numerous digital graphical images. In alternative embodiments, data 205 may comprise of type of data such as video files, software applications or audio files, for example. While data sharing application 206 of FIG. 2 is separate from hotspot service 207, in alternative embodiments of the invention, data sharing application 206 may reside within hotspot service 207 as a subroutine or child application of hotspot service 207. The capabilities of data sharing application 206 will be discussed in more detail in the descriptions for FIGS. 3, 4a, 4b, and 5.

FIG. 3 is an illustration of an exemplary presenter device for presenting, onto a plurality of participant devices, a plurality of data contents, according to one embodiment of the present invention. Presenter device 301 of FIG. 3 includes display screen 302. Display screen 302 includes sharing window 303, path box 304, browse button 305, select or notify button 306, start session button 307, next image button 308, previous image button 309, text message field 311, and exit button 313. Sharing window 303 includes graphical image 312. Presenter device 301 may correspond to presenter device 101 of FIG. 1.

Display screen 302 may be any type of display component such as, for example, a liquid crystal display (LCD) screen. In one embodiment, display screen 302 may be a touch sensitive LCD screen. Display screen 302 may display the graphical user interface (GUI) components available for use during the use of data sharing application 206 of FIG. 2. In one embodiment, the GUI components include sharing window 303, path box 304, browse button 305, select or notify button 306, start session button 307, next image button 308, previous image button 309, text message field 311, and exit button 313. The functionalities of GUI components shown in FIG. 3 may be suited for presenting digital images. In alternative embodiments, if presenter device 301 shares audio files, video files, or other types of data files, then a different set of GUI components may be selected and displayed in order to suit the presentation needs of those video files, audio files, or other types of data files.

Browse button 305, which may be any type of graphical button, may function as a typical search button to browse for and select the plurality of data contents stored. Using browse button 305 to select data files causes data sharing application 206 to receive a selection of the plurality of data contents. The data path of the plurality of data contents may be displayed in path box 304, which may be any type of text box. Using select or notify button 306 may cause data sharing application 206 to connect to the plurality of participant devices using a hotspot service executing on presenter device 301. As explained earlier, presenter device 301 may choose to connect to a plurality of participant devices selected from among the participant devices physically present within the hotspot signal range. After connecting to the plurality of participant devices, text message field 311 may be used to send text messages to and receive text message from the plurality of participant devices. Moreover, in alternative embodiments, data sharing application 206 may even connect to another plurality of participant devices that may be outside the hotspot signal range by using conventional connection methods, such as using Internet based dynamic domain name system (DNS) servers, for example. After connecting to the plurality of participant devices, user of presenter device 301 may use start session button 307 to cause data sharing application 206 to establish a sharing session with the plurality of participant devices. As will be described in further detail below, a sharing session may give the plurality of participant devices temporary ability to view any presented data contents within presenter device 301. In alternative embodiments, establishing the sharing session with the plurality of devices may be automatically performed after presenter device 301 connects to the plurality of participant devices.

Using next image button 308 or previous image button 309 may cause data sharing application 206 to present, on the participant devices, the plurality of data contents. In the embodiment shown in FIG. 3, next image button 308 may be used to present the initial data content, if no contents have been presented yet, or the next digital image from the plurality of data contents. Previous image button 309 may be used to present the last data content, if no contents have been presented yet, or the previous digital image from the plurality of data contents. Exit button 313 may be used to end the sharing session.

Sharing window 303 may be any dialog window or web browser. Sharing window may display the data contents that are being shown on the display screens of the plurality of participant devices. In FIG. 3, only graphical image 312 is being displayed in sharing window 303. In other embodiments of the invention multiple data contents may be displayed within sharing window 303.

In one embodiment of the invention, presenting the plurality of data contents includes controlling and synchronizing the presentation of the plurality of data contents shown on the plurality of participant devices. Any data content shown in sharing window 303 for a particular duration may also be simultaneously shown in the plurality of participant devices during the same duration. Furthermore, data sharing application 206 may be configured to prevent users of the plurality of participant devices from copying or downloading the plurality of data contents from the plurality of participant devices.

In one embodiment, data sharing application 206 may also be configured to send a download invitation to the plurality of participant devices. The download invitation may be any type of dialog box or web browser presenting an opportunity for the plurality of participant devices to download the plurality of data contents being shared. Data sharing application 206 may be further configured to allow the plurality of participant devices to download the plurality of data contents in response to receiving an acceptance of the download invitation. In alternative embodiments, the data sharing application 206 may not be configured to send the download invitation. Select or notify button 306 may also be used to send the download invitation to the plurality of participant devices.

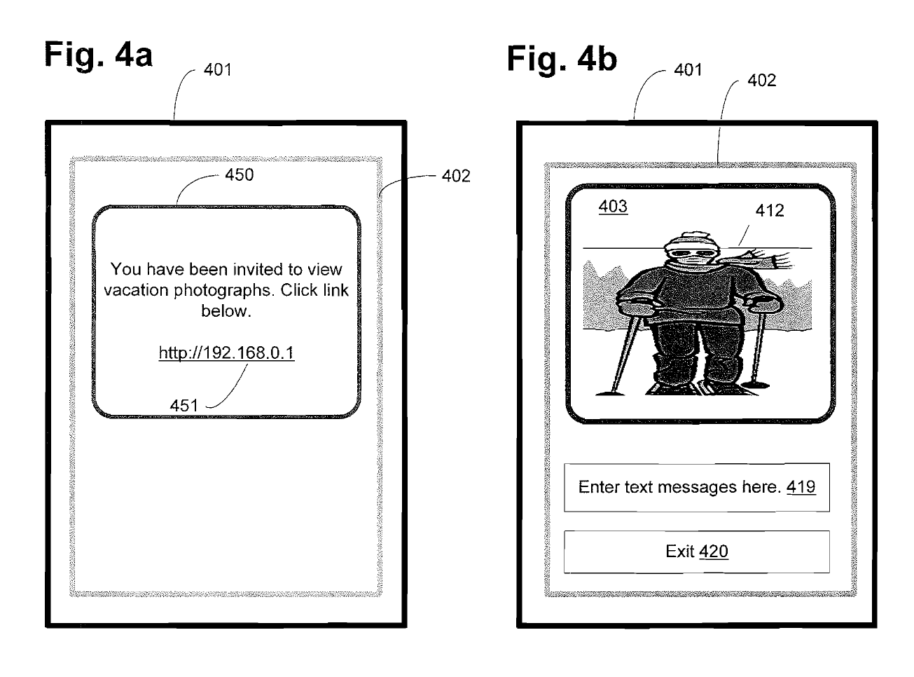

FIG. 4a presents an illustration of one participant device receiving a share invitation from a presenter device, according to one embodiment of the present invention. Participant device 401a of FIG. 4a includes display screen 402a and dialog 450. Dialog 450 includes web link 451 or other location link. Participant device 401a may correspond to either one of participant devices 103 and 104 of FIG. 1.

Display screen 402a may be any type of display device such as a liquid crystal display (LCD) monitor, for example. In one embodiment, display screen 402a may be a touch sensitive LCD monitor. Dialog 450 may be any dialog box such as a dialog window, a web browser, or any other type of graphical dialog box. In FIG. 4a, dialog 450 may be a web browser. Web link 451 may be hyperlink associated with an Internet Protocol (IP) address to a web server residing on the presenter device. Web link 451 may be a hyperlink associated with a private IP address designated by the presenter device acting as a wireless router. Thus, web link 451 may allow participant device 401a to access the web server residing on the presenter device even if presenter device or participant device 401a may not be connected to network 108 of FIG. 1, which may be the Internet.

As previously described, once data sharing application 206 of FIG. 2 connects to the plurality of participant devices, including participant device 401a, using a hotspot service executing within the presenter device, data sharing application 206 may have several methods of establishing a sharing session with participant device 401a. In the embodiment shown in FIG. 4a, establishing a sharing session may include transmitting a share invitation to the plurality of participant devices and allowing that plurality of participant devices to access the web server in the memory of the presenter device in response to receiving an acceptance of the share invitation by the plurality of participant devices. An acceptance in this instance may comprise clicking on the web link 451 or entering the IP address represented by web link 451 into the location bar a web browser. FIG. 4b illustrates the events after participant device 401a accepts web link 451.

FIG. 4b presents an illustration of participant device 401a of FIG. 4a presenting data content stored on a presenter device after accepting a share invitation, according to one embodiment of the present invention. Participant device 401b of FIG. 4b includes display screen 402h, sharing window 403, graphical image 412, text message box 419 and exit button 420. Participant device 401b and display screen 402b may correspond to participant device 401a and display screen 402a of FIG. 4a, respectively. Graphical image 412 may correspond to graphical image 312 of FIG. 3.

Once web link 451 of FIG. 4a has been used to access the web server on the presenter device, a sharing session may be successfully established between presenter device and participant device 401b, and presenter device may present the plurality of data contents on participant device 401b. In the present embodiment, presenter device may configure data sharing application 206 of FIG. 2, prior to presenting the plurality of data contents, to convert the plurality of data contents into a hypertext markup language (HTML) presentable format for display in a web browser. For example, if the plurality of data contents includes videos or audio, that plurality of data contents may be converted into HTML presentable format by embedding the video and/or audio data into one or more web pages and store web pages into web server within presenter device for participant device 401b to view through a web browser launched on participant device 401b. In alternative embodiments, the plurality of data contents may be converted into any other type of presentable format to accommodate other methods of presentation, including other graphical display tools such as proprietary application windows, for example.

In one embodiment, participant device 401b may view graphical image 412, which has been converted into HTML presentable format and stored into the web server of presenter device, using sharing window 403. As previously described, sharing window 403 may be a web browser accessing the web server of presenter device at the IP address specified by web link 451 of FIG. 4a. As will be explained below, in alternative embodiments there may be different methods of viewing the plurality of data contents on the presenter device from the plurality of participant devices, including participant device 402a.

Text message box 491 may be used to communicate with the presenter device by sending text messages to and receiving text messages from the presenter device. User of participant device 401b may also exit the sharing session and stop further viewing of the plurality of data contents on the presenter device by using exit button 420. Accordingly, FIGS. 4a and 4b, together, may represent an embodiment of the invention in which the presenter device, running data sharing application 206, may establish a sharing session by sending a share invitation and receiving an acceptance of the share invitation.

In alternative embodiments of the invention, data sharing application 206 may be configured such that establishing a sharing session may include automatically directing all web accesses from the plurality of participant devices toward the web server in the presenter device. As previously explained, the plurality of data contents selected for presentation may be stored within the web server of presenter device. By directing all web access from the plurality of participant devices, including participant device 401a, to the web server, presenter device may automatically present the plurality of data contents on the plurality of participant devices once the plurality of participant devices launches any web browser.

Data sharing application 206 may be configured to automatically direct all web access towards the web server within presenter device by using a dynamic host configuration protocol (DHCP) server of the presenter device to set a domain name system (DNS) server address of the plurality of participant devices to the IP address of the presenter device. It is well known that conventional hotspot generation applications, such as hotspot service 207 of FIG. 2, may allow presenter device to become a wireless router with a DNS server. It is also well known that the presenter device, configured as a router, may comprise a DHCP server. Data sharing application 206, using DHCP server, may configure all the DNS server addresses of the plurality of participant devices to correspond to the IP address of the presenter device. Data sharing application 206 may further configure the DNS server of the presenter device to direct all web access from the plurality of participant devices towards the web server in presenter device. Accordingly, in one embodiment, once presenter device connects to the plurality of participant devices, the sharing session may be automatically established and the plurality of participant devices may be directed to access only the web server in the presenter device when the plurality of participant devices launches any web browsers.

In yet another alternative embodiment, data sharing application 206 may be configured such that establishing a sharing session includes connecting to a participant viewing application executing on the plurality of participant devices. The participant viewing application may be another application running on the plurality of participant devices. The plurality of participant devices may receive a participant viewing application from the presenter device or from another source, such as a third-party web server on the Internet, for example. The participant viewing application, when executing, may create an application dialog window on the participant device. Once the sharing session may be established, the application dialog window may display the plurality of data contents selected for presentation on the presenter device. Establishing a sharing session with the participant viewing application may obviate the need to store the plurality of data contents into a web server in presenter device. Accordingly, in this alternative embodiment, participant device 401a may not need to access that web server to view the data contents nor have all web access directed to the web server. In alternative embodiments, the presenter device may cause participant viewing application to execute on the plurality of participant devices.

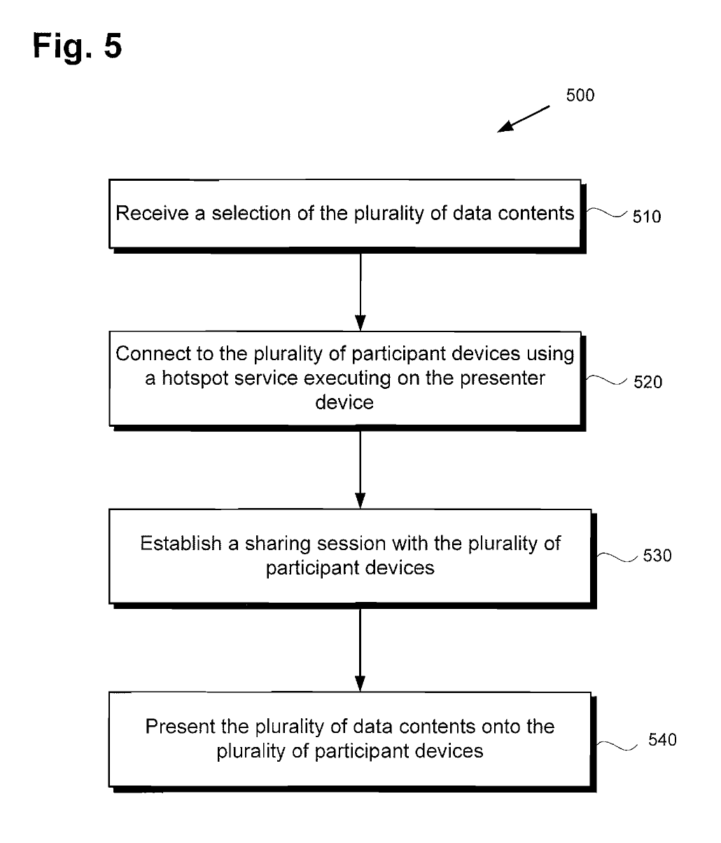

FIG. 5 shows a flowchart describing the steps, according to one embodiment of the present invention, by which a plurality of data contents may be presented onto a plurality of participant devices present within a hotspot signal range, according to one embodiment of the present invention. Certain details and features have been left out of flowchart 500 that are apparent to a person of ordinary skill in the art. Thus, a step may comprise one or more sub-steps or may involve specialized equipment or materials, for example, as known the art. While steps 510 through 540 indicated in flowchart 500 are sufficient to describe one embodiment of the present method, other embodiments may utilize steps different from those shown in flowchart 500, or may include more, or fewer steps.

Referring to step 510 of flowchart 500 in FIG. 5 and block diagram 200 of FIG. 2, and presenter device 301 of FIG. 3, step 510 of flowchart 500 comprises data sharing application 206, executed by processor 202, receiving a selection of a plurality of data contents. As previously explained, browse button 305 may be used to browse for and select the plurality of data contents from data 205 in memory 203.

Proceeding to step 520 of flowchart 500 of FIG. 5 and environment 100 of FIG. 1, block diagram 200 of FIG. 2 and presenter device 300 of FIG. 3, step 520 of flowchart 500 comprises data sharing application 206, executed by processor 202, connecting to the plurality of participant devices using hotspot service 207 executing on presenter device 201. As previously explained, presenter device 101 may connect to the plurality of participant devices 103 and 104 through hotspot signal 102 generated by hotspot service 207 since both participant devices 103 and 104 are within hotspot signal range 106. Select or notify button 306 may be used to select a plurality of participant devices for connection with presenter device 101 from among all of the mobile devices physically present within hotspot signal range 106. In one embodiment, both participant devices 103 and 104 may be part of the plurality of participant devices. In other embodiments, one mobile device may be selected.

Proceeding to step 530 of flowchart 500 of FIG. 5 and environment 100 of FIG. 1, block diagram 200 of FIG. 2 and presenter device 300 of FIG. 3, step 530 of flowchart 500 comprises data sharing application 206, executed by processor 202, establishing a sharing session with the plurality of participant devices. After connecting to the plurality of participant devices in step 520, presenter device 101 may establish a sharing session with the plurality of participant devices in order to present the plurality of data contents selected from step 510 on the plurality of participant devices. As previously explained, in one embodiment, using start session button 307 may cause data sharing application 206 to start a sharing session with the plurality of participant devices connected to in step 520. In the embodiment shown in FIG. 5, establishing the sharing session may entail transmitting a sharing invitation to the plurality of participant devices, and receiving an acceptance of the sharing invitation from the plurality of participant devices. Moreover, as explained previously, the sharing session may be established automatically, or by connecting to a participant viewing application running on the plurality of participant devices, as well.

Proceeding to step 540 of flowchart 500 of FIG. 5 and environment 100 of FIG. 1, block diagram 200 of FIG. 2, presenter device 300 of FIG. 3, and participant device 401a and 401b of FIGS. 4a and 4b, respectively, step 540 of flowchart 500 comprises data sharing application 206, executed by processor 202, presenting the plurality of data contents from step 510 onto the plurality of participant devices. By using next image button 308 or previous image button 309, the user of presenter device 301 may cycle through the plurality of data contents by presenting one data content at a time on the plurality of participant devices. The plurality of data contents may be presented through presenter server 204. The image shown on sharing window 303, such as graphical image 312, in one embodiment, may be simultaneously shown on the plurality of participant devices as graphical image 412 in sharing window 403 of participant device 401b.

Thus, a system and method for sharing a plurality of data contents from a presenter device to a plurality of participant devices has been disclosed. Accordingly, the presenter device, using data sharing application 206 of FIG. 2, maintains full control over the presentation method and ownership of the plurality of data contents. In another embodiment, a participant device may present from the participant device through the presenter device, provided that the presenter device has provided authorization to the participant device, however, the presenter device, using data sharing application 206 of FIG. 2, maintains full control over the presentation method. Existing sharing methodologies can thus be more flexibly utilized for quick and convenient sharing of data content from one mobile device to a plurality of mobile devices.

From the above description of the invention it is manifest that various techniques can be used for implementing the concepts of the present invention without departing from its scope. Moreover, while the invention has been described with specific reference to certain embodiments, a person of ordinary skills in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangement, modifications, and substitutions without departing from the scope of the invention.

What is claimed is:

1. A presenter device for presenting, to a plurality of participant devices, a plurality of data contents, the presenter device comprising:
a memory configured to store a data sharing application; and
a processor configured to execute the data sharing application in the memory, the data sharing application configured to:
receive a selection of the plurality of data contents;
connect to the plurality of participant devices using a hotspot service executing on the presenter device;
establish a sharing session with the plurality of participant devices; and
present the plurality of data contents to the plurality of participant devices.

2. The presenter device of claim 1, wherein the data sharing application is further configured to:
send a download invitation to the plurality of participant devices; and
allow the plurality of participant devices to download the plurality of data contents in response to receiving an acceptance of the download invitation.

3. The presenter device of claim 1, wherein the data sharing application, prior to presenting, is configured to convert the plurality of data contents into a hypertext markup language (HTML) presentable format.

4. The presenter device of claim 1, wherein the establishing comprises automatically directing all web access from the plurality of participant devices to a web server in the memory.

5. The presenter device of claim 4, wherein the directing comprises using a dynamic host configuration protocol (DHCP) server of the presenter device to set a domain name system (DNS) server address of the plurality of participant devices to an Internet Protocol (IP) address of the presenter device.

6. The presenter device of claim 1, wherein establishing further comprises:
transmitting a share invitation to the plurality of participant devices; and
allowing the plurality of participant devices to access a web server in the memory in response to receiving an acceptance of the share invitation.

7. The presenter device of claim 6, wherein the share invitation comprises a web link.

8. The presenter device of claim 1, wherein establishing comprises connecting to a participant viewing application executing on the plurality of participant devices.

9. The presenter device of claim 1, wherein presenting comprises controlling and synchronizing the presentation of the plurality of data contents shown on the plurality of participant devices.

10. The presenter device of claim 1, wherein connecting further comprises connecting to another plurality of participant devices outside a hotspot signal range of the hotspot service.

11. A method for presenting, to a plurality of participant devices, a plurality of data contents from a presenter device, the method comprising:
receiving a selection of the plurality of data contents;
connecting to the plurality of participant devices using a hotspot service executing on the presenter device;
establishing a sharing session with the plurality of participant devices; and
presenting the plurality of data contents onto the plurality of participant devices.

12. The method of claim 11, further comprising:
sending a download invitation to the plurality of participant devices; and
allowing the plurality of participant devices to download the plurality of data contents in response to receiving an acceptance of the download invitation.

13. The method of claim 11, wherein the data sharing application, prior to presenting, is configured to convert the plurality of data contents into hypertext markup language (HTML) presentable format.

14. The method of claim 11, wherein the establishing comprises automatically directing all web access from the plurality of participant devices to a web server in the memory.

15. The method of claim 14, wherein the directing comprises using a dynamic host configuration protocol (DHCP) server of the presenter device to set a domain name system (DNS) server address of the plurality of participant devices to an Internet Protocol (IP) address of the presenter device.

16. The method of claim 11, wherein establishing further comprises:
transmitting a share invitation to the plurality of participant devices; and
allowing the plurality of participant devices to access a web server in the memory in response to receiving an acceptance of the share invitation.

17. The method of claim 16, wherein the share invitation comprises a web link.

18. The method of claim 11, wherein establishing comprises connecting to a participant viewing application executing on the plurality of participant devices.

19. The method of claim 11, wherein presenting comprises controlling and synchronizing the presentation of the plurality of data contents shown on the plurality of participant devices.

20. The method of claim 11, wherein connecting further comprises connecting to another plurality of participant devices outside a hotspot signal range of the hotspot service.
